(19) United States
(12) Patent Application Publication
(10) Pub. No.: US 2026/0235045 A1
(43) Pub. Date: Aug. 13, 2026

(54) DEVICE FOR CENTERING AND ROTATIONALLY GUIDING A SHAFT LINE OF A TURBINE ENGINE, AND TURBINE ENGINE

(71) Applicant: SAFRAN HELICOPTER ENGINES, BORDES (FR)

(72) Inventors: Emmanuel Jean-Marc TONICELLO, MOISSY-CRAMAYEL (FR); Lionel Victor George RENAULT, MOISSY-CRAMAYEL (FR); Antoine Bernard CHRISTOPHE, MOISSY-CRAMAYEL (FR); Frédéric Ferdinand Jacques BATLLE, MOISSY-CRAMAYEL (FR)

(21) Appl. No.: 19/153,449

(22) PCT Filed: Feb. 2, 2024
(86) PCT No.: PCT/FR2024/050139

§ 371 Date: Aug. 4, 2025

(30) Foreign Application Priority Data
Feb. 7, 2023 (FR) 2301137

(51) Int. Cl. F01D 25/16; F16C 19/16; F16C 19/54; F16C 27/04

(52) U.S. Cl. CPC F01D 25/16; F16C 19/163; F16C 19/546; F16C 27/045; F05D 2240/54; F16C 2360/23

(57) ABSTRACT

A device for centering and rotationally guiding a shaft line of a turbine engine includes a first inner ring fixed to the shaft line, a first outer ring, a first ball bearing arranged between the first inner ring and the first outer ring, and a first support supporting the first outer ring. The device also includes a second inner ring fixed to the shaft line, a second outer ring, a second bearing arranged between the second inner ring and the second outer ring, and a flexible cage supporting the second outer ring. The stiffness of the first support is greater than the stiffness of the flexible cage, and the second bearing is spaced apart from the first ball bearing by a predefined axial spacing.

### TECHNICAL FIELD OF THE INVENTION

The field of this invention is that of aeronautical turbine engines, and more particularly of devices for centering and rotationally guiding a shaft line of a turbine engine.

### PRIOR ART

The bearings present on the shaft lines of a gas turbine have a fixed or set radial stiffness. This stiffness does not change on the basis of one or more parameters when the engine is operating.

It is known to arrange a single bearing per bearing device. This bearing may be mounted in a “rigid” support or mounted in a flexible cage.

The stiffness of this flexible cage is calibrated so as to limit the presence of modes of vibration within the operating range of the engine, as much as possible. The dynamic situation of a shaft line is therefore said to be fixed because the positioning of the modes of vibration does not change, due to the stiffness of fixed bearing devices. For example, in engine architectures containing a through-shaft, a first mode of vibration of the shaft is traversed when the engine speed is increased to reach the engine's nominal operating range. This first mode of vibration of the shaft generally has a high percentage of elastic deformation energy, and is positioned outside and at a distance from the engine's nominal operating range.

A second mode of vibration is then often present within or beyond the engine's nominal operating range. This second mode of vibration is often too close to the engine speed at the maximum permissible speeds.

It is also known to arrange two bearings in a bearing device, for example as described in patent FR2951232. However, these two bearings do not have a stiffness that varies on the basis of an engine parameter.

### PRESENTATION OF THE INVENTION

The aim of the present invention is to propose a device for centering and rotationally guiding a shaft line, having a stiffness in one or more bearings which varies on the basis of at least one engine parameter such as, for example, the axial thrust of the engine or the rotation speed of the engine.

### SUMMARY OF THE INVENTION

The present invention relates to a centering and guiding device for centering and rotationally guiding a shaft line of a turbine engine, the shaft line capable of being driven to rotate about an axis of rotation, said device comprising:
a first inner ring fixed to a shaft line, a first outer ring, a first ball bearing arranged between the first inner ring and the first outer ring, a first support supporting the first outer ring, the first support having a defined stiffness,
a second inner ring fixed to the shaft line, a second outer ring, a second bearing arranged between the second inner ring and the second outer ring, and a flexible cage supporting the second outer ring, characterized in that the stiffness of the flexible cage is less than the stiffness of the first support and in that the second bearing is spaced apart from the first bearing by a predefined axial spacing. The present invention allows improving the dynamic analyses of the shaft line. Advantageously, the present invention allows changing, through the variation in the axial thrust, the stiffness in the centering and guiding device, also called a bearing device, as a function of the engine speed.

The features described in the following paragraphs may optionally be implemented. They may be implemented independently of one another or in combination with one another:

From a perspective of shaft deformation energy, the present invention advantageously minimizes the energies in the shaft line for the two modes of vibration present in the vicinity of the engine's operating range.

The features described in the following paragraphs may optionally be implemented. They may be implemented independently of one another or in combination with one another:
The first ball bearing, the first outer ring, and the first support are shaped such that a first clearance is provided between the first ball bearing and the first outer ring; the second ball bearing, the second outer ring, and the flexible cage are shaped so that a second clearance is provided between the second bearing and the second outer ring; the first clearance having a greater dimension in a radial direction than the second clearance.

Advantageously, at low speed and under low axial load, the second clearance is absorbed. The stiffness of the centering and guiding device corresponds to the stiffness of the flexible cage. Under high axial load, the radial stiffness of the centering and guiding device gradually approaches the radial stiffness of the first bearing.
The predefined axial spacing is less than four times the diameter of the balls of the ball bearing, so that the difference between the bulk temperature of the first inner ring and the bulk temperature of the second inner ring is less than 20°.
The predefined axial spacing is chosen so as to ensure that the shaft line is statically determinate.
The second bearing is a roller bearing.
A ring of oil (called a squeeze film) surrounds the second bearing.
The first ball bearing has curvatures of between 0.51 and 0.52, so as to guarantee a low radial stiffness of the centering and rotationally guiding device, under low axial load.

The invention also relates to a turbine engine comprising a frame; a shaft line arranged in the frame, said shaft line being suitable for driving the rotation of a turbine; and a centering and rotationally guiding device for centering and rotationally guiding said shaft line according to the characteristics mentioned above, said centering and guiding device being mounted on at least one shaft line among the shaft line of a speed reducer, the shaft line of an accessory drive chain, a front portion of the shaft line of a gas generator, and the shaft line of a free turbine.

### BRIEF DESCRIPTION OF FIGURES

FIG. 1 is a schematic view of a turbine engine;

FIG. 2 is a schematic view of a centering and guiding device a shaft line according to the present invention, the centering and guiding device being represented with the turbine engine stopped;

FIG. 3 is a schematic view similar to the view in FIG. 2, the centering and guiding device being represented with the turbine engine operating at low speed and under low load;

FIG. 4 is a schematic view similar to the view in FIG. 2, the centering and guiding device being shown with the turbine engine operating under high axial load;

FIG. 5 is a graph showing the evolution of the thrust or axial force as a function of the engine speed;

FIG. 6 is a graph showing the evolution of the stiffness in the centering and guiding device as a function of the engine speed;

FIG. 7 is a graph showing the unbalance response of the shaft line as a function of the engine speed when the shaft line is mounted in a flexible cage, when it is mounted in a rigid supporting structure, and when it is mounted in a centering and guiding device according to the invention.

### DETAILED DESCRIPTION OF THE INVENTION

The present invention relates to a centering and guiding device 12 for centering and rotationally guiding a shaft line of a turbomachine 1.

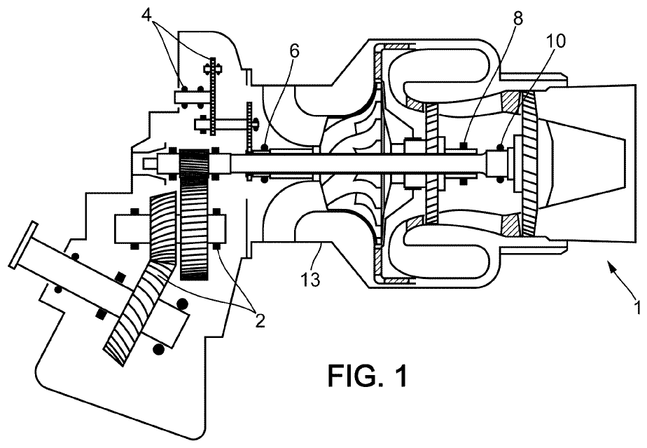

With reference to FIG. 1, the device 12 according to the invention may advantageously be placed on the bearing devices and pinions of the speed reducer 2, on the bearing devices and pinions of the accessory drive chain 4, on the front bearing device of the gas generator 6, and on the bearing device of the free turbine 10.

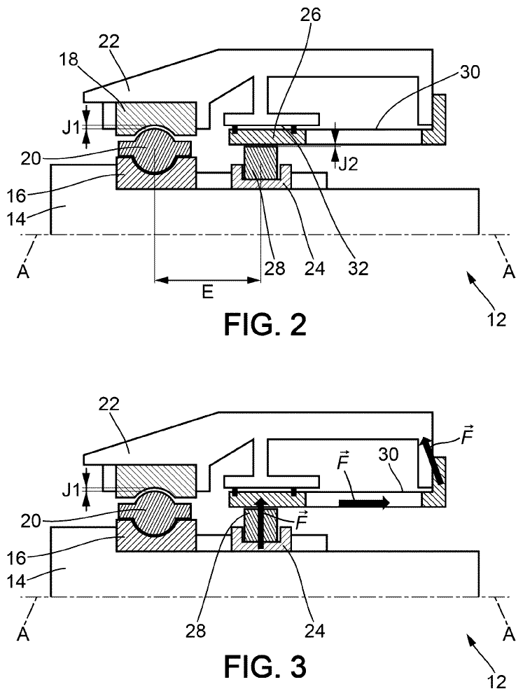

With reference to FIGS. 1 and 2, the centering and guiding device 12 according to the invention, also called a bearing device, is arranged between a frame 13 and a shaft line 14 or drive shaft mounted to rotate about an axis of rotation A-A.

The centering and rotationally guiding device 12 comprises a first inner ring 16 fixed to the shaft line 14, a first outer ring 18, a first bearing 20 arranged between the first inner ring and the first outer ring, and a first support 22 supporting the first outer ring. The first bearing 20 is a ball bearing.

The radii of curvature of the ball bearing are defined so as to ensure a low radial stiffness under a low axial load.

The first ball bearing, the first outer ring, and the first support are shaped so that a first clearance J1 is provided between the first bearing 20 and the first outer ring 18. The centering and rotationally guiding device 12 comprises a second inner ring 24 fixed to the shaft line 14, a second outer ring 26, a second bearing 28 arranged between the second inner ring 24 and the second outer ring 26, and a flexible cage 30 supporting the second outer ring.

The second bearing 28 is, for example, a roller bearing.

Alternatively, the second bearing 28 is a tapered roller bearing or some other bearing.

An example of a flexible cage is described in patent application FR 3098 239, filed in the name of the Applicant.

Preferably, a squeeze film 32 surrounds the second bearing.

This squeeze film constitutes a damping device. An example of such a damping device is also described in patent application FR 3098 239. Advantageously, this squeeze film 32 greatly limits the expansion of the outer ring of the second bearing, due to an oil temperature that is lower than the temperature of the outer ring of the bearing.

The first ball bearing 20 is characterized by more dissipated power than the second bearing 28, thus allowing for greater expansion of the component elements of the bearing.

The second bearing 28, the second outer ring 24, and the flexible cage 30 are shaped so that a second clearance J2 is provided between the second bearing 28 and the second outer ring 26.

Advantageously, the first clearance J1 has a dimension in a radial direction R that is greater than the second clearance J2, as can be seen in FIG. 2.

Also advantageously, the second bearing 28 is spaced apart from the first bearing 20 by a predefined axial spacing E so as to ensure an almost identical shaft line temperature for the two bearings.

This predefined axial spacing E is sufficiently small to ensure similar average temperatures for the first inner ring 16 and for the second inner ring 24, which helps to control the clearance hierarchy.

Advantageously, this predefined axial spacing E ensures that the shaft line is statically determinate.

The predefined axial spacing E is less than four times the diameter of the balls of the ball bearing, so that the difference between the bulk temperature of the first inner ring 16 and the bulk temperature of the second inner ring 24 is less than 20°.

The first support 22 is a rigid support. It has a defined stiffness K1.

The flexible cage 30 has a determined stiffness K2 that is less than the stiffness K1 of the first support.

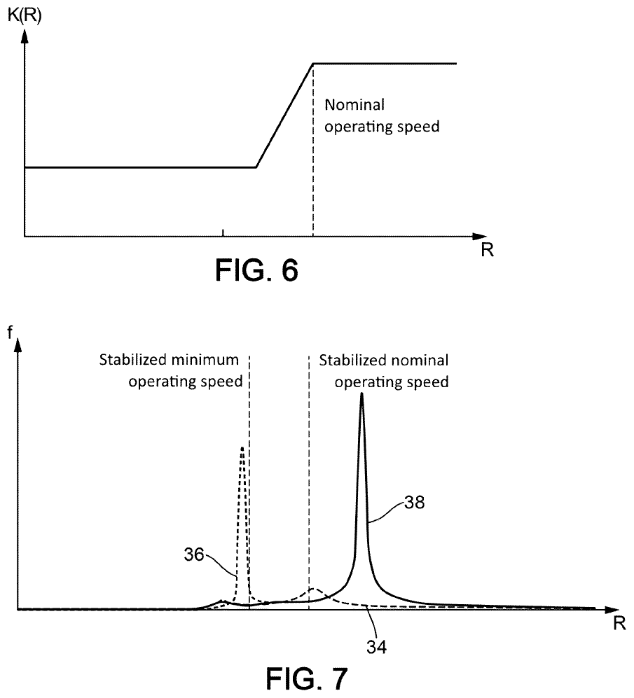

Advantageously, the centering and guiding device 12 has an overall radial stiffness K(R) that varies as a function of the engine speed R, as can be seen in FIG. 6 and as explained below.

FIG. 3 shows the centering and guiding device 12 when the turbine engine is operating at low speed and under low load.

With reference to FIG. 3, during phases of operation at low speed and under low axial load, radial displacement of the shaft line 14 directly stresses the second bearing 28 mounted in the flexible cage 30. At that moment, the stiffness K(R) of the centering and guiding device 12 is that of the flexible cage 30. The first ball bearing 20 is not stressed or is only slightly stressed, due to the fact that the first clearance J1 is greater than the second clearance J2.

At low speed and under low axial load, the second clearance J2 is absorbed. The stiffness of the centering and guiding device corresponds to the stiffness of the flexible cage 30. This makes it possible to position, with sufficient margin, the first mode of vibration to be overcome so it is below the desired stabilized operating range of the shaft line.

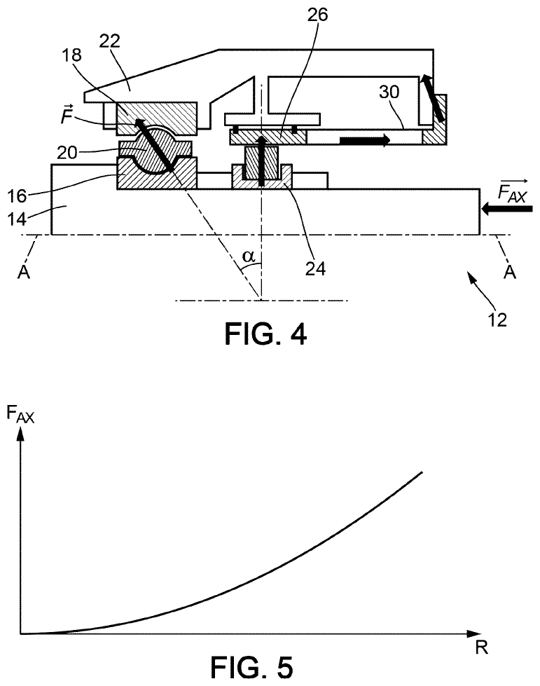

FIG. 4 shows the centering and guiding device 12 when the turbine machine is in operation.

When the speed increases, the axial thrust (Fax) increases, and the clearance J1 in the first bearing 20 is reduced so as to gradually take up the radial load on the centering and guiding device 12. Thus, the second bearing 28 is less and less stressed and the radial stiffness K(R) of the centering and guiding device 12 gradually switches to the radial stiffness of the first ball bearing 20 until this axial load is so significant in comparison to the radial load that the second bearing 28 is relieved in favor of the first ball bearing 20 as illustrated in FIG. 4.

The second mode of the shaft line is then pushed beyond and at a distance from the operating speeds, due to this increase in stiffness of the centering and guiding device. This thus allows ensuring a satisfactory situation for the positioning of the critical speeds at the highest operating speeds.

Furthermore, by judiciously choosing the spacing E between the two bearings, the load angle a allows guaranteeing the statically determinate character of the assembly as illustrated by the dotted lines in FIG. 4. Thus, the spacing E between the first bearing 20 and the second bearing 28 must be managed during the design phase in order to guarantee this condition. The predefined axial spacing E thus serves to guarantee the hierarchy of the clearance between the two bearings but also the statically determinate character of the assembly.

During the engine shutdown phase, the trend is reversed. The axial thrust decreases with the decrease in engine speed, and, in this example, the centering and guiding device once again behaves like a flexible bearing device. This once again allows overcoming the first mode of vibration under satisfactory conditions.

With reference to FIG. 5, the axial force (Fax) applied to the shaft line 14 increases when the engine speed R increases.

FIG. 7 shows the unbalance response of the shaft line as a function of the engine speed when the shaft line is mounted in a flexible cage (curve 34), when it is mounted in a rigid supporting structure (curve 36), and when it is mounted in a centering and guiding device 12 according to the invention (curve 38).

With reference to FIG. 7, as shown by curve 34, when the shaft line is mounted in a flexible bearing device, the forces generated on the bearing device are reduced but a second mode of vibration is positioned in the vicinity of the operating speed. The second mode of vibration is positioned too close to the nominal operating speed of the engine.

As shown by curve 36, when the shaft line is mounted in a stiff bearing device, the forces generated on the bearing device are significant and the first mode of vibration is close to the operating range of the engine.

As shown in curve 38, when the shaft line is mounted in a centering and guiding device 12 according to the invention, the first mode of vibration is sufficiently low in speed and is damped. The second mode of vibration is pushed outside of the nominal operating range of the engine speed.

Ultimately, the mode of vibration present at the top of the operating range is pushed away by the change in stiffness. However, the level of force on the bearing device for the first mode of vibration, as well as the position of the first mode of vibration, remain identical to a solution using a flexible bearing device. In the stabilized nominal operating speed, the forces in the bearing devices are also significantly reduced in comparison to the configuration with a flexible bearing device.

Advantageously, the centering and guiding device 12 thus provides the benefits of a flexible bearing device and the benefits of a stiff bearing device.

From a perspective of shaft deformation energy, the present invention advantageously minimizes the energies in the shaft line for the two modes of vibration present around the engine's operating range.

1. Centering and rotationally guiding device for centering and rotationally guiding a shaft line of a turbine engine, the shaft line capable of being driven to rotate about an axis of rotation, said device comprising:
a first inner ring fixed to the shaft line, a first outer ring, a first ball bearing arranged between the first inner ring and the first outer ring, a first support supporting the first outer ring,
a second inner ring fixed to the shaft line, a second outer ring, a second bearing arranged between the second inner ring and the second outer ring, and a flexible cage supporting the second outer ring; and the second bearing is spaced apart from the first ball bearing by a predefined axial spacing,
wherein the stiffness of the first support is greater than the stiffness of the flexible cage, and
wherein the first ball bearing, the first outer ring, and the first support are shaped such that a first clearance is provided between the first ball bearing and the first outer ring; the second bearing, the second outer ring, and the flexible cage are shaped so that a second clearance is provided between the second bearing and the second outer ring; the first clearance having a greater dimension in a radial direction than the second clearance.

2. The device according to claim 1, wherein the predefined axial spacing is less than four times the diameter of balls of the first ball bearing.

3. The device according to claim 1, wherein the second bearing is a roller bearing.

4. The device according to claim 1, wherein a squeeze film surrounds the second bearing.

5. The device according to claim 1, wherein the first ball bearing has curvatures of between 0.51 and 0.52 so as to guarantee a low radial stiffness of the centering and rotationally guiding device under low axial load.

6. A turbine engine comprising a frame; a shaft line arranged in the frame, said shaft line being suitable for driving the rotation of a turbine; and a centering and guiding device for centering and rotationally guiding said shaft line, the shaft line capable of being driven to rotate about an axis of rotation, said device comprising:
a first inner ring fixed to a shaft line, a first outer ring, a first ball bearing arranged between the first inner ring and the first outer ring, a first support supporting the first outer ring,
a second inner ring fixed to the shaft line, a second outer ring, a second bearing arranged between the second inner ring and the second outer ring, and a flexible cage supporting the second outer ring; and the second bearing is spaced apart from the first ball bearing by a predefined axial spacing,
said centering and guiding device being mounted on at least one shaft line among the shaft line of a speed reducer, the shaft line of an accessory drive chain, a front portion of the shaft line of a gas generator, and the shaft line of a free turbine wherein the stiffness of the first support is greater than the stiffness of the flexible cage, the first ball bearing, the first outer ring, and the first support are shaped such that a first clearance is provided between the first ball bearing and the first outer ring; the second bearing, the second outer ring, and the flexible cage are shaped so that a second clearance is provided between the second bearing and the second outer ring; the first clearance having a greater dimension in a radial direction than the second clearance.
